(19) United States
(12) Patent Application Publication
(10) Pub. No.: US 2009/0196637 A1
(43) Pub. Date: Aug. 6, 2009

(54) FUSER UNIT FOR IMAGE FORMING APPARATUS

(75) Inventor: Toshiya INOMATA, Chigasaki-shi (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/364,758

(22) Filed: Feb. 3, 2009

Related U.S. Application Data
(60) Provisional application No. 61/026,685, filed on Feb. 6, 2008.

(51) Int. Cl. G03G 21/20

(52) U.S. Cl. 399/44

(57) ABSTRACT

An embodiment of the present invention relates to a fuser unit including first and second temperature detecting mechanisms that detect the temperature at the center in an axial direction of a first roller member in non-contact with the first roller member, a third temperature detecting mechanism that detects the temperature at an end in the axial direction of the first roller member and in an area where a developer carried by a bearing member is not present, and fourth and fifth temperature detecting mechanisms that detect the temperature at the center in an axial direction of a second roller member in non-contact with the second roller member. The detecting mechanism that detects the temperature in the area (the position) where the developer carried by the bearing member is not present may come into contact with the first roller member.

### CROSS-REFERENCE TO RELATED APPLICATION

This application is based upon and claims the benefit of priority from U.S. Provisional Application No. 61/026,685 filed on Feb. 6, 2008, the entire contents of each of which are incorporated herein by reference.

### TECHNICAL FIELD

The present invention relates to a fuser unit for use in an image forming apparatus that fixes a thermofusible toner on a sheet material.

### BACKGROUND

An image forming apparatus called MFP (Multi-Functional Peripheral) is well-known.

The MFP generally develops a latent image (an electrostatically formed image) with a thermofusible toner and heats a toner image obtained by developing the latent image to fix the toner image on a sheet material. In fixing the toner image, usually, the MFP applies fixed or larger pressure to the sheet material and the toner (the toner image).

In order to apply the fixed or larger pressure to the sheet material and the toner, the sheet material (and the toner on the sheet material) that bears the toner (the toner image) is moved between circumferential surfaces, which are in contact with each other, of two rollers whose axes are arrayed substantially parallel to each other. One of the rollers or both the rollers may take a form of a belt.

Two or more temperature sensors measure the temperatures at specific positions of the two rollers or the belt.

At least one of the temperature sensors measures the temperature generally in the center in an axial direction of the rollers or generally in the center along an axis of a driving shaft of the belt.

At least one of the other temperatures sensors measures the temperature at an end in the axial direction of the rollers or at an end in an axial direction of the driving shaft of the belt.

There is also widely known an example in which at least one sensor is a contact type on both a heat roller or belt side and a press roller side. In this example, two non-contact sensors and one contact sensor are provided on the heat roller or belt side and one non-contact sensor and one contact sensor are provided on the press roller side.

For example, JP-A-2005-316418 (Patent Document 1) discloses that at least three temperature sensors measure the temperatures generally at the center in an axial direction of a roller, at an end, and at an edge, which is an end, where a toner image is not present.

Patent Document 1 does not deny that one or more temperature sensors are the non-contact type. However, there is no detailed description concerning a sensor that is indispensably the non-contact type or a sensor that is preferably the non-contact type.

It is well-known that, when the temperature sensor of the contact type is used, (an output of) temperature as a detection result fluctuates (is unstable) because soil adhere to roller surfaces or the belt, (friction) scratches occur on the roller surfaces or the belt, and the toner adheres to a detection surface of the sensor.

It is also well-known that cleaning pads are attached (to the roller surfaces or the belt) to prevent soil on the roller surfaces or the belt from adhering to the sheet material when the sensor comes into contact with the roller surfaces or the belt.

### SUMMARY

It is an object of the present invention to provide a fuser unit that solves the problems in that (an output of) temperature as a detection result of a sensor fluctuates (is unstable) because soil adheres to roller surfaces or a belt, (friction) scratches occur on the roller surfaces or the belt, and a toner adheres to a detection surface of the sensor.

According to an aspect of the present invention, there is provided a fuser unit including: a first roller member (a belt) that comes into contact with a developer on a bearing member; a second roller member (a press roller) that applies pressure to the bearing member and the developer on the bearing member; a first heating mechanism that raises temperature of the first roller member; a second heating mechanism that raises temperature of the second roller member; a first temperature detecting mechanism that detects temperature at a center in an axial direction of the first roller member in non-contact with the first roller member; a second temperature detecting mechanism that detects temperature at a specific position between the center and an end in the axial direction of the first roller member in non-contact with the first roller member; a third temperature detecting mechanism that detects temperature at the end in the axial direction of the first roller member and in an area (a position) where the developer carried by the bearing member is not present; a fourth temperature detecting mechanism that detects temperature at a center in an axial direction of the second roller member in non-contact with the second roller member; and a fifth temperature detecting mechanism that detects temperature at a specific position between the center and an end in the axial direction of the second roller member in non-contact with the second roller member.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram of an example of an image forming apparatus (a multi-functional peripheral (MFP)) according to an embodiment of the present invention;

FIG. 2 is a diagram of an example (in a direction orthogonal to an axis) of a fuser unit included in the MFP shown in FIG. 1;

FIG. 3 is a diagram of positions of sensors in an axial direction of the fuser unit shown in FIG. 2;

FIG. 4 is a list of attaching positions of temperature sensors of the fuser unit shown in FIG. 3;

FIG. 5 is a schematic diagram of a fuser unit according to another embodiment included in the image forming apparatus shown in FIG. 2 viewed from a direction parallel to a rotation axis;

FIG. 6 is a list of attaching positions of temperature sensors of the fuser unit shown in FIG. 5; and

FIG. 7 is a perspective view of position of sensor of the fuser unit shown in FIG. 5.

### DETAILED DESCRIPTION

An embodiment of the present invention is explained in detail below with reference to the accompanying drawings.

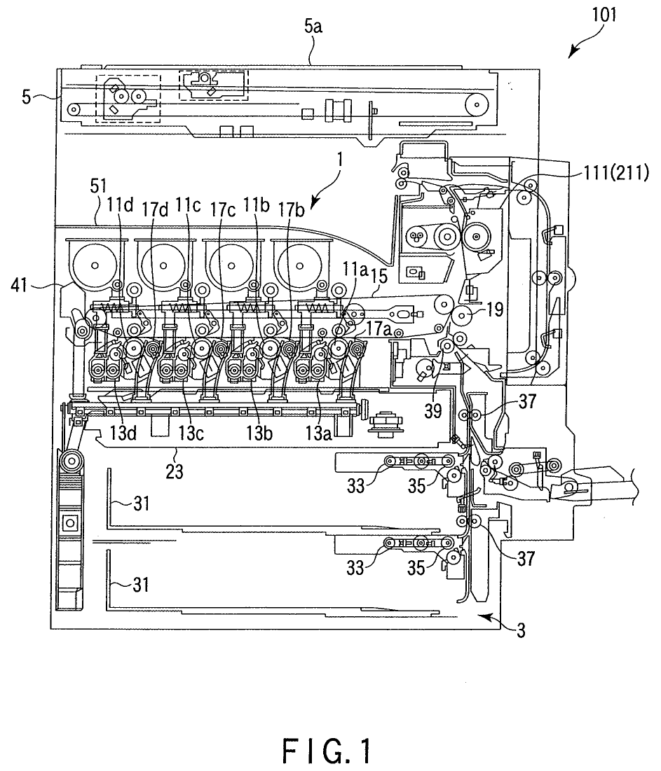

FIG. 1 is a schematic diagram of an image forming apparatus (a multi-functional peripheral (MFP)) to which the present invention can be applied.

An image forming apparatus 101 shown in FIG. 1 includes an image forming unit main body 1 that outputs image information as an “image output” referred to as, for example, “hard copy” or “print out” in a state in which a toner image is fixed on a sheet material, a sheet feeding unit 3 that can feed sheets (output media) of arbitrary sizes used for the image output to the image forming unit main body 1, and an image scanning unit 5 that captures the image information, which is an object to be formed as an image in the image forming unit main body 1, as image data from a scanning object having the image information (hereinafter referred to as original document).

Although not explained in detail, the image scanning unit 5 includes a document table (a document glass) 5a that supports an original document and an image sensor, for example, a CCD sensor that converts the image information into image data. The image scanning unit 5 converts, using the CCD sensor, reflected light obtained by irradiating illumination light from an illuminating device, which is not explained, onto the original document set on the document table 5a into an image signal.

The image forming unit main body 1 includes first to fourth photoconductive drums 11a to 11d that bear latent images, developing devices 13a to 13d that supply developers, i.e., toners to the latent images born on the photoconductive drums 11a to 11d to develop the latent images, a transfer belt 15 that bears, in order, images of the toners born on the photoconductive drums 11a to 11d, cleaners 17a to 17d that remove the toners remaining on the photoconductive drums 11a to 11d from the respective photoconductive drums 11a to 11d, a transfer device 19 that transfers the toner images born on the transfer belt 15 onto a sheet material, i.e., plain paper or a sheet-like medium such as an OHP sheet as a transparent resin sheet, a fuser unit 111 that fixes the toner images on the sheet material onto which the toner images are transferred, an exposing device 21 that forms latent images on the photoconductive drums 11a to 11d and the like.

The first to fourth developing devices 13a to 13d store toners of arbitrary colors, i.e., Y (yellow), M (magenta), C (cyan), and Bk (black), used for obtaining a color image according to a subtractive process. The first to fourth developing devices 13a to 13d visualize the latent images respectively born on the photoconductive drums 11a to 11d with the colors of Y, M, C, and Bk, respectively. Order of the colors is determined as predetermined order according to an image forming process and properties of the toners.

The transfer belt 15 bears, in order (of formation of the toner images), the toner images of the respective colors formed by the first to fourth photoconductive drums 11a to 11d and the developing devices 13a to 13d corresponding thereto.

The sheet feeding unit 3 feeds the sheet material, onto which the toner images are transferred, at predetermined timing.

Cassettes, which are not explained in detail, located in plural cassette slots 31 store sheet materials of arbitrary sizes. According to an image forming operation not explained in detail, pickup rollers 33 take out the sheet materials from the cassettes corresponding thereto. A size of the sheet materials corresponds to a magnification requested in image formation and the size of the toner images formed by the image forming unit main body 1.

Separating mechanisms 35 prevent two or more sheet materials from being taken out from the cassettes by the pickup rollers 33.

Plural conveying rollers 37 feed the one sheet material separated by the separating mechanisms 35 to aligning rollers 39.

The aligning rollers 39 feed the sheet material to a transfer position, where the transfer device 19 and the transfer belt 15 are in contact with each other, to coincide with timing when the transfer device 19 transfers the toner images from the transfer belt 15.

The fuser unit 111 fixes the toner images corresponding to the image information on the sheet material and sends, as an image output (hard copy or print out), the toner images to a stock space 51 located in a space between the image scanning unit 5 and the image forming unit main body 1.

The transfer belt 15 bears the toners remaining thereon (hereinafter referred to as waste toners) and moves the waste toners to a predetermined position according to the movement of a belt surface thereof. A belt cleaner 41 that is in contact with the transfer belt 15 at a predetermined position removes the waste toners born on the belt surface of the transfer belt 15 from the transfer belt 15.

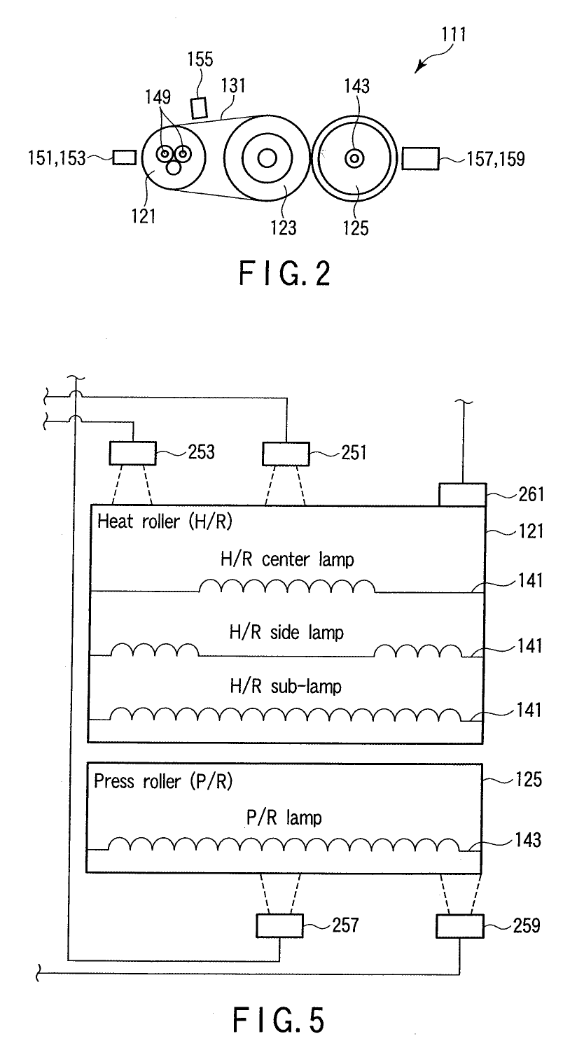

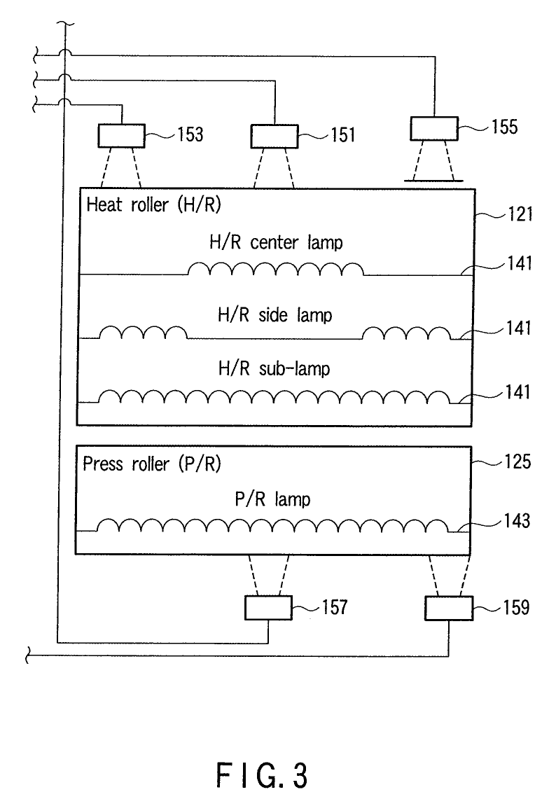

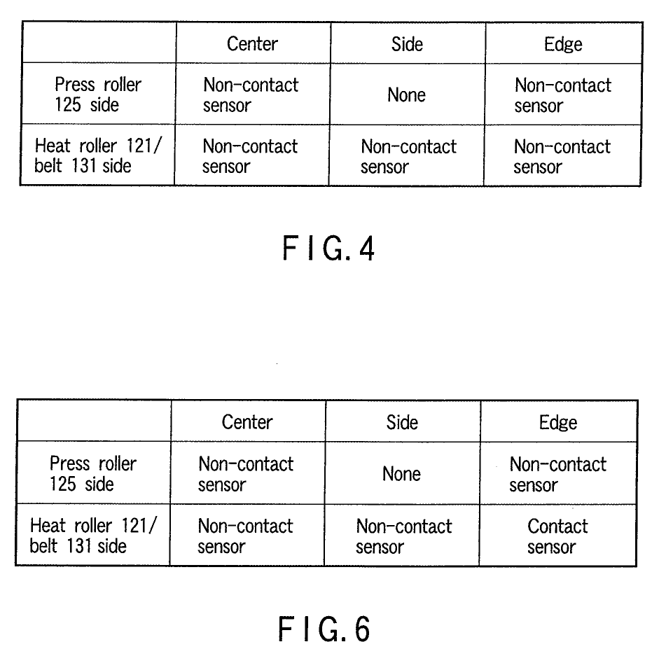

FIG. 2 is a diagram of the fuser unit 111 included in the image forming apparatus 101 shown in FIG. 1 in a state viewed from a direction orthogonal to a rotation axis. FIG. 3 is a schematic diagram of the fuser unit 111 shown in FIG. 2 in a state viewed from a direction parallel to the rotation axis. FIG. 4 is a list of attaching positions of temperature sensors of the fuser unit 111 shown in FIG. 3.

As shown in FIGS. 2 and 3, the fuser unit 111 includes first to third roller members 121, 123, and 125. Axes of the first to third roller members 121, 123, and 125 are parallel to one another and located on substantially the same surface (cylindrical surface or plane). Among the first to third roller members 121, 123, and 125, one of the roller members (121 or 125), on both sides of which the other roller members are not located, and the remaining roller member 123 are located on an inner side of a belt 131 that covers outer circumferences of both the roller members. For example, the belt 131 covers the first roller member 121 and the second roller member 123. An arbitrary position of a belt surface of the belt 131 moves in a predetermined direction according to the rotation of the first roller member 121 or the second roller member 123. The surface of the belt 131 is in contact with the other one roller member (in this embodiment, the third roller member) 125. Therefore, the arbitrary position of the belt surface of the belt 131 may move in the predetermined direction as a result of the rotation of the third roller member 125.

Of the roller members located on the inner side of the belt 131, the roller member (in this embodiment, the third roller member) 125, which is in contact with the belt 131, and the roller member (in this embodiment, the first roller member) 121, which is away from a position where the belt 131 and the roller member 125 are in contact with each other, include heating mechanisms (heater elements) 141 and 143.

The heating mechanisms 141 and 143 are located, for example, on inner sides of the first and third roller members 121 and 125. The heating mechanisms 141 and 143 may be located on outer sides of the first and third roller members 121 and 125. The heating mechanisms 141 and 143 include, for example, lamps or induction coils. At least one of the heating mechanisms 141 and 143 may be a lamp and the other may be an induction coil. If the heating mechanisms 141 and 143 are the lamps, two or more lamps are allowed to be located in one roller member. If the two or more lamps are located in one roller member, different arrays of heat generating areas of the lamps are allowed in an axial direction of the roller member. In other words, a heat generating area of an arbitrary lamp is offset from a heat generating area of the other lamp in the axial direction of the roller member. Therefore, the roller member acquires a temperature distribution in the axial direction of the roller member.

If the heating mechanisms 141 and 143 are the induction coils, one coil unit is allowed to electrically include (as components of a resonant circuit) two or more unit coils. At least one of coil unit of the heating mechanisms 141 and 143 is allowed to include two or more unit coils, at least two of the unit coils are allowed to be located in series along the axial direction of the roller members or the belt.

In the following explanation, the first roller member 121 is referred to as heat roller, the second roller member 123 is referred to as fuse roller, and the third roller member 125 is referred to as press roller.

Therefore, the belt 131 acquires heat generated by the heat roller (the first roller member) 121 and the press roller (the third roller member) 125.

The fuser unit 111 includes at least five (first to fifth) temperature sensors 151, 153, 155, 157, and 159.

The first temperature sensor 151 detects the temperature of the belt 131, for example, at substantially the center in the axial direction of the heat roller 121. The second temperature sensor 153 detects the temperature of the belt 131, for example, at a predetermined position between the substantial center in the axial direction and an end in the axial direction of the heat roller 121. The third temperature sensor 155 detects the temperature, for example, at a substantial end in the axial direction of the heat roller 121 and in a section (an area) where a toner image is not located on the belt 131. All of the first to third temperature sensors 151, 153, and 155 are non-contact type sensors that do not come into contact with the belt 131 as a target of temperature detection.

The fourth temperature sensor 157 detects the temperature on the surface of the press roller 125 at substantially the center in the axial direction of the press roller 125. The fifth temperature sensor 159 detects the temperature at a substantial end in the axial direction of the press roller 125 and on the surface of a section (an area) where a toner image is not present on a sheet material that moves between press roller 125 and the belt 131.

Although not explained in detail, the fuser unit 111 is allowed to further include a sixth sensor that detects the temperature on the surface of the press roller 125 at a predetermined position between the substantial center in the axial direction and an end in the axial direction of the press roller 125. Both the fourth and fifth temperature sensors 157 and 159 are non-contact type sensors that do not come into contact with the surface of the press roller 125 as a target of temperature detection.

The fuser unit 111 keeps fixed pressure between the belt 131 and the press roller (the third roller member) 125. Therefore, a toner on the sheet material that passes between the belt 131 and the press roller 125 is fixed on the sheet material by acquired pressure.

The fact that all the temperature sensors in the fuser unit 111 are the non-contact type sensors solves the problems in that scratches occur on the surface of the belt 131 in contact with a toner and the surface of the press roller 125 and a temperature output as a detection result is unstable because the toner adheres to detection surfaces of the sensors. Further, it is unnecessary to attach, to the roller surfaces or the belt, cleaning pads for preventing the toner from being transferred. Therefore, it is possible to further reduce the likelihood that scratches occur on the surface of the belt 131 in contact with the toner and the surface of the press roller 125 because the sensors are in contact with the roller surfaces or the belt.

Since all the temperature sensors are the non-contact type sensors, if there is a request for reversal of the rollers or the belt of the fuser unit in a relation of jam processing, specific conveyance control for a sheet material, and the like, it is unnecessary to take into account a conveying direction of the sensors (the sensors are usually pressed against the rollers or the belt by force in a forward rotating direction or a non-reversing direction).

FIG. 5 is a schematic diagram of a fuser unit according to another embodiment included in the image forming apparatus 101 shown in FIG. 1 viewed from a direction parallel to the rotation axis. FIG. 6 is a list of attaching positions of temperature sensors of the fuser unit shown in FIG. 5.

A fuser unit 211 shown in FIG. 5 includes the first to third roller members 121, 123, and 125 substantially the same as those of the fuser unit 111 shown in FIG. 2. The belt 131 is located in the same manner as that of the fuser unit 111. Further, the fuser unit 211 includes the heating mechanisms 141 and 143 substantially the same as those of the fuser unit 111 shown in FIG. 2.

The fuser unit 211 shown in FIG. 5 includes at least five (first to fifth) temperature sensors 151, 153, 157, 159 and 261.

The first temperature sensor 151, the second temperature sensor 153, the fourth temperature sensor 157, and the fifth temperature sensor 159 are non-contact type sensors substantially the same as those of the fuser unit 111 shown in FIG. 2.

The third temperature sensor 261 that detects the temperature, for example, at a substantial end in the axial direction of the heat roller 121 and in a section (an area) where a toner image is not located on the belt 131 includes a temperature detecting element 263.

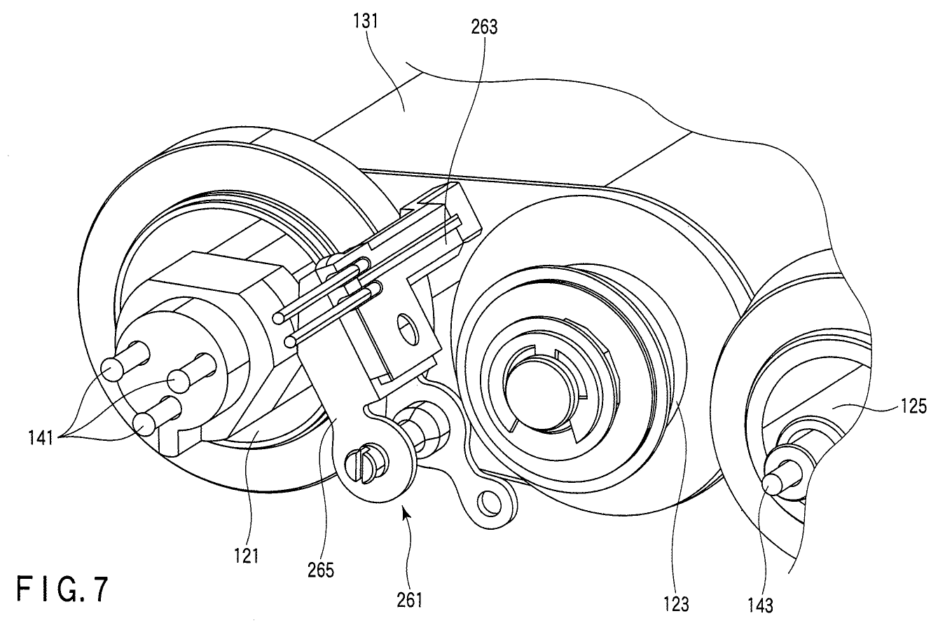

The temperature detecting element 263 is located, as indicated by an example shown in FIG. 7, on the inner side of the belt 131 and in a space (a gap) between the heat roller 121 and the fuse roller 123 determined by a distance between axes of the roller 121 and the roller 123 and diameters of both the rollers. A holder 265 supports the temperature detecting element 263. Although not explained in detail, the holder 265 rotates around a fulcrum 265a. Consequently, the temperature detecting element 263 comes into contact with, for example, the surface of the heat roller 121.

The fuser unit 211 keeps fixed pressure between the belt 131 and the press roller (the third roller member) 125. Therefore, a toner on the sheet material that passes between the belt 131 and the press roller 125 is fixed on the sheet material by acquired pressure.

When it is difficult to attach (insert) the temperature detecting element 263 (the third temperature sensor 261) in a space in the inside of the belt 131 (the space explained above is small), it is easy to locate only a detecting unit (the temperature detecting element 263) of the sensor on an inner side of the belt 131, since the third temperature sensor 261 in the fuser unit 211 that detects the temperature on the surface of the heat roller 121 at a predetermined position between the heat roller (the first roller member) 121, which moves in a predetermined position of the belt 131 and maintains the tension of the belt 131, and the fuse roller (the second roller member) 123 is a contact type sensor.

Therefore, the holder 265 of the third temperature sensor 261 and, although not shown in the figure, a harness and the like connected to the temperature detecting element 263 (the third temperature sensor 261) are located on an outer side of the belt 131 (the space explained above).

Consequently, the harnesses and the like of the sensors are unlikely to be caught in the heat roller as the roller member and the belt. Therefore, the MFP is reduced in size.

The width (the axial direction length) of the belt 131 of the fuser unit 111 (or 211) is 305 mm to 330 mm.

This width is 10 mm larger than the width (e.g., 320 mm) of a largest sheet, on which an image can be formed, in the specification of the MFP (the image forming apparatus 101) and is equal to or larger than the maximum width (305 mm) for image formation.

By adopting such a configuration, when all the temperature sensors are non-contact type sensors, the problems in that scratches occur on the surface of the belt 131 in contact with a toner and the surface of the press roller 125 and a temperature output as a detection result is unstable because the toner adheres to detection surfaces of the sensors are solved.

Further, it is unnecessary to attach, to the roller surfaces or the belt, cleaning pads for preventing the toner from being transferred. Therefore, it is possible to further reduce the likelihood that scratches occur on the surface of the belt 131 in contact with the toner and the surface of the press roller 125 because the sensors are in contact with the roller surfaces or the belt. Since all the temperature sensors are the non-contact type sensors, if there is a request for reversal of the rollers or the belt of the fuser unit in a relation of jam processing, specific conveyance control for a sheet material, and the like, it is unnecessary to take into account a conveying direction of the sensors (the sensors are usually pressed against the rollers or the belt by force in a forward rotating direction or a non-reversing direction).

Moreover, since the temperature sensor that detects the temperature on the surface of the heat roller at a predetermined position between the heat roller and the press roller is allowed to be a contact type sensor, it is possible to adopt an array in which only the temperature detecting element of the temperature sensor is located on the inner side of the belt. Therefore, it is possible to prevent an unfavorable event that, for example, the harness and the like come into contact with the belt and the rollers, twine between the belt and the rollers, twine around the rollers.

Therefore, the MFP (the image forming apparatus) is reduced in size.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuser unit comprising:
a first roller member configured to contact with a developer on a bearing member;
a second roller member configured to apply pressure to the bearing member and the developer on the bearing member;
a first heating mechanism configured to raise temperature of the first roller member;
a second heating mechanism configured to raise temperature of the second roller member;
a first temperature detecting mechanism configured to detect temperature at a center in an axial direction of the first roller member in non-contact with the first roller member;
a second temperature detecting mechanism configured to detect temperature at a specific position between the center and an end in the axial direction of the first roller member in non-contact with the first roller member;
a third temperature detecting mechanism configured to detect temperature at the end in the axial direction of the first roller member and in an area where the developer carried by the bearing member is not present;
a fourth temperature detecting mechanism configured to detect temperature at a center in an axial direction of the second roller member in non-contact with the second roller member; and
a fifth temperature detecting mechanism configured to detect temperature at a specific position between the center and an end in the axial direction of the second roller member in non-contact with the second roller member.

2. The unit of claim 1, wherein the third temperature detecting mechanism is in non-contact with the first roller member.

3. The unit of claim 1, wherein the third temperature detecting mechanism is in contact with the first roller member.

4. The unit of claim 2, further comprising:
a third roller member that is located on an inner side of the first roller member, moves in an arbitrary position in the axial direction of the first roller member, and includes the first heating mechanism; and
a fourth roller member that is located on the inner side of the first roller member and applies tension to the first roller member.

5. The unit of claim 3, further comprising:
a third roller member that is located on an inner side of the first roller member, moves in an arbitrary position in the axial direction of the first roller member, and includes the first heating mechanism; and
a fourth roller member that is located on the inner side of the first roller member and applies tension to the first roller member.

6. The unit of claim 5, wherein the third temperature detecting mechanism is located in a space between the third roller member and the fourth roller member on the inner side of the first roller member.

7. The unit of claim 6, wherein
the third temperature detecting mechanism includes a temperature detecting element, and
a harness and the like connected to the temperature detecting element are located on an outer side of the space.

8. The unit of claim 6, wherein
the third temperature detecting mechanism includes a temperature detecting element, and
an element that supports the temperature detecting element is located on an outer side of the space.

9. The unit of claim 1, wherein at least one of the first and second heating mechanisms includes a lamp or an induction heater.

10. The unit of claim 9, wherein, if at least one of the first and second heating mechanisms is the induction heater, the induction heater is located from an outer side along a circumferential surface of the first or second roller member claim 1, wherein at least one of the first and second heating mechanisms includes a lamp or an induction heater.

11. An image forming apparatus comprising:
a fuser unit including:
at least one a first roller member and first belt member configured to contact with a developer on a bearing member;
a second roller member configured to apply pressure to the bearing member and the developer on the bearing member;
a first heating mechanism configured to raise temperature of the first roller member;
a second heating mechanism configured to raise temperature of the second roller member;
a first temperature detecting mechanism configured to detect temperature at a center in an axial direction of the one of the first roller member or first belt member in non-contact with the first roller member or first belt member;
a second temperature detecting mechanism configured to detect temperature at a specific position between the center and an end in the axial direction of the first roller member or first belt member in non-contact with the first roller member or first belt member;
a third temperature detecting mechanism configured to detect temperature at the end in the axial direction of the first roller member or first belt member in an area where the developer carried by the bearing member is not present;
a fourth temperature detecting mechanism configured to detect temperature at a center in an axial direction of the second roller member in non-contact with the second roller member; and
a fifth temperature detecting mechanism configured to detect temperature at a specific position between the center and an end in the axial direction of the second roller member in non-contact with the second roller member;
a bearing member moving mechanism configured to move the bearing member and the developer on the bearing member to between the first roller member and the second roller member; and
a developer image forming mechanism configured to form, on the basis of image information, a developer image that is transferred by the bearing member.

12. The apparatus of claim 11, wherein the third temperature detecting mechanism is in non-contact with the first roller member.

13. The apparatus of claim 11, wherein the third temperature detecting mechanism is in contact with the first roller member.

14. The apparatus of claim 12, further comprising:
a third roller member that is located on an inner side of the first roller member, moves in an arbitrary position in the axial direction of the first roller member, and includes the first heating mechanism; and
a fourth roller member that is located on the inner side of the first roller member and applies tension to the first roller member.

15. The apparatus of claim 13, further comprising:
a third roller member that is located on an inner side of the first roller member, moves in an arbitrary position in the axial direction of the first roller member, and includes the first heating mechanism; and
a fourth roller member that is located on the inner side of the first roller member and applies tension to the first roller member.

16. The apparatus of claim 14, wherein the third temperature detecting mechanism is located in a space between the third roller member and the fourth roller member on the inner side of the first roller member.

17. The apparatus of claim 15, wherein
the third temperature detecting mechanism includes a temperature detecting element, and
a harness and the like connected to the temperature detecting element are located on an outer side of the space.

18. The apparatus of claim 16, wherein
the third temperature detecting mechanism includes a temperature detecting element, and
an element that supports the temperature detecting element is located on an outer side of the space.

19. The apparatus of claim 11, wherein at least one of the first and second heating mechanisms includes a lamp or an induction heater.

20. The apparatus of claim 19, wherein, if at least one of the first and second heating mechanisms is the induction heater, the induction heater is located from an outer side along a circumferential surface of the first or second roller member.

21. An image forming apparatus comprising:
means for forming a toner image;
means for conveying a sheet material with the toner image; and
means for fixing the toner image on the sheet material including:
fourth means for rotating and for fusing the toner image on the sheet material;
fifth means for rotating and for pressing the toner image on the sheet material;
sixth means for heating the fourth means;
seventh means for heating the fifth means;
eighth means for detecting temperature of a center of the fourth means along an axis in non-contact with the fourth means;
ninth means for detecting temperature of a portion between the center and an end of the fourth means along an axis in non-contact with the fourth means;
tenth means for detecting temperature of an end area having no toner image on the sheet material of the fourth means along an axis in non-contact with the fourth means;
eleventh means for detecting temperature of a center of the fifth means along an axis in non-contact with the fifth means; and
twelfth means for detecting temperature of a portion between the center and an end of the fifth means along an axis in contact with the fifth means.
